(19) United States
(12) Patent Application Publication
(10) Pub. No.: US 2026/0320382 A1
(43) Pub. Date: Oct. 15, 2026

(54) PHYSICS-ENFORCED DEEP LEARNING CALIBRATION AND DATA-MIXING TRANSFER LEARNING METHODS

(71) Applicant: Schlumberger Technology Corporation, Sugar Land, TX (US)

(72) Inventors: Saad Omar, Cambridge, MA (US); Laurent Mosse, Paris (FR); Jeffrey Miles, Cambridge, MA (US); Wail Benrabh, Cambridge, MA (US)

(21) Appl. No.: 19/467,192

(22) Filed: Feb. 2, 2026

Related U.S. Application Data
(60) Provisional application No. 63/754,950, filed on Feb. 6, 2025.

(51) Int. Cl. G06N 3/08

(52) U.S. Cl. CPC G06N 3/08

(57) ABSTRACT

Techniques and systems for training and deploying a machine learning model. This includes receiving first data, receiving second data, training a machine learning (ML) model of a neural network utilizing training data based upon the first data to generate a first trained ML model, isolating a first set of layers of the neural network from a second set of layers of the neural network, training a portion of the first trained ML model of the second set of layers of the neural network utilizing the second data to generate a fully trained ML model, and deploying the fully trained ML model on a data processing system to interpret received measurements collected in conjunction with a natural resource operation.

### CROSS-REFERENCE TO RELATED APPLICATIONS

This application is a Non-Provisional Application claiming priority to U.S. Provisional Patent Application No. 63/754,950, entitled “PHYSICS-ENFORCED DEEP LEARNING CALIBRATION AND DATA_MIXING TRANSFER LEARNING METHODS”, filed Feb. 6, 2025, which is herein incorporated by reference.

### BACKGROUND

The subject matter disclosed herein relates to systems and methods to increase efficiencies in generation of formation estimations via well logging tools.

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Producing hydrocarbons from a wellbore drilled into a geological region is a remarkably complex endeavor. In many cases, decisions involved in hydrocarbon exploration and production may be informed by measurements from downhole well-logging tools that are conveyed deep into the wellbore. The measurements may be used to infer properties or characteristics of the geological region surrounding the wellbore.

Well logging tools, such as downhole tools, are utilized to measure well properties for well evaluation. These logging tools can include, for example, electromagnetic logging tools, nuclear magnetic resonance tools, gamma ray logging tools, neutron tools, and other types of logging tools. The logging tools can be utilized in conjunction with logging-while-drilling (LWD) operations or mapping-while-drilling operations in which formation evaluation measurements (e.g., resistivity, porosity, etc.) are taken during drilling operations. The measurements made by the logging tools can be useful in providing, for example, bed boundary detection as well as delineation of reservoir boundaries and fluid contacts in a formation. However, generation of these results based upon the measurements made by the logging tools has become increasingly complex.

### BRIEF DESCRIPTION OF THE DRAWINGS

Various aspects of this disclosure may be better understood upon reading the following detailed description and upon reference to the drawings in which:

FIG. 1 depicts an example wellsite system for measuring borehole data using various downhole tools and surface tools, in accordance with embodiments of the present disclosure;

FIG. 2 depicts a well control system and logging tool that operate in conjunction with the wellsite system of FIG. 1 to perform natural resource operations, in accordance with embodiments of the present disclosure;

FIG. 3 depicts an example of a nuclear logging tool as the logging tool of FIG. 1, in accordance with embodiments of the present disclosure;

FIG. 4 depicts a flow chart describing a first example of training and implementation of a machine learning model in the well logging tool of FIG. 2, in accordance with embodiments of the present disclosure;

FIG. 5 depicts a flow chart describing a second example of training and implementation of a machine learning model in the well logging tool of FIG. 2, in accordance with embodiments of the present disclosure; and

FIG. 6 depicts a flow chart describing a third example of training and implementation of a machine learning model in the well logging tool of FIG. 2, in accordance with embodiments of the present disclosure.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Downhole tools, for example, electromagnetic (EM) logging tools, nuclear magnetic resonance tools, gamma ray logging tools, neutron tools, and other types of logging tools have grown more sophisticated. For example, logging tools are capable of providing advanced downhole measurements, which can produce a large number of measurement logs. Many types of formation evaluation logs, e.g., resistivity, acoustic, and nuclear, may be recorded using logging tools, for example, logging while drilling (LWD) tools, and the data collected may be used to control aspects of the drilling process, for example, determining a well plan and/or controlling a desired trajectory as determined by the well plan. That is, the formation evaluation data resultant from measurements collected by the logging tools can be used, for example, in well planning and/or to implement various physical actions, for example, control of drilling operations.

The data collected by the logging tools can be utilized by machine learning (ML) models to generate the formation evaluation data. However, training of these machine learning models can be difficult, as training data collection is expensive and time-consuming. Present embodiments include a data-mixing based ML/deep learning (DL) training method to generalize controlled lab measurements applications to field data and a methodology to (a) generate high-fidelity tool measurements and (b) interpret tool measurements using learnings from low-fidelity but generalizable modeling databases. Techniques herein can be applied, for example, when the physics of the problem is known in an approximate sense (low-fidelity physics e.g. low complexity numerical codes) and where relatively few high-fidelity (lab or field) data inputs are available. Even within the high-fidelity data, lab measurements may not be exposed to real-life settings e.g. weak motional emf effects in electromagnetic tools, road noise in logging tools, complex and unknown lithology formations etc. and techniques herein for generation of a ML model are provided that take into account this aspect of the lab measurements to provide a ML model that generates improved formation characterization data.

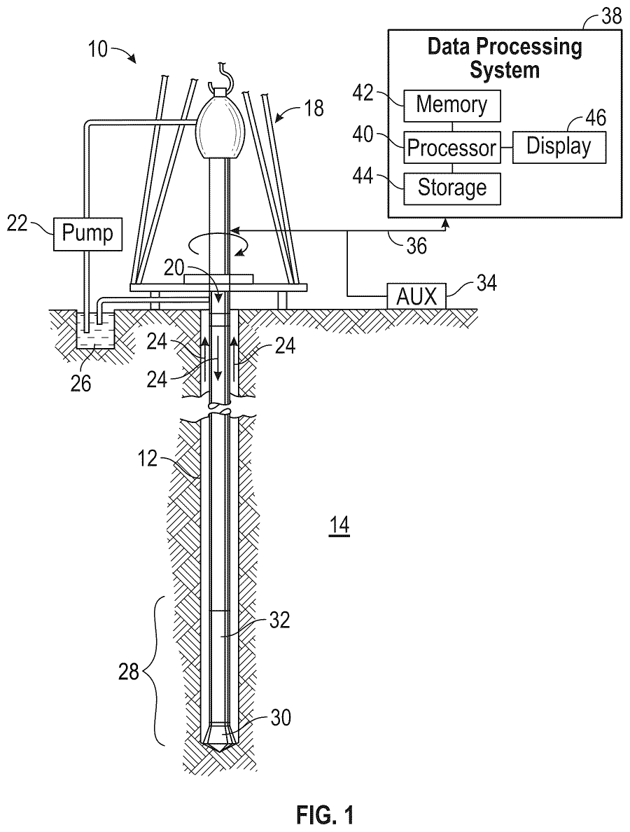

With the foregoing in mind, FIG. 1 illustrates a drilling system 10 that may employ the systems and methods of this disclosure. The drilling system 10 may be used to drill a borehole 12 into a geological region 14. In the drilling system 10, a drilling rig 18 may rotate a drill string 20 within the borehole 12. As the drill string 20 is rotated, a drilling fluid pump 22 may be used to pump drilling fluid, which may be referred to as “mud” or “drilling mud,” downward through the center of the drill string 20, and back up around the drill string 20, as shown by reference arrows 24. At the surface, return drilling fluid may be filtered and conveyed back to a mud pit 26 for reuse. The drilling fluid may travel down to the bottom of the drill string 20 known as the bottom-hole assembly (BHA) 28. The drilling fluid may be used to rotate, cool, and/or lubricate a drill bit 30 that may be a part of the BHA 28. The fluid may exit the drill string 20 through the drill bit 30 and carry drill cuttings away from the bottom of the borehole 12 back to the surface.

The BHA 28 may include the drill bit 30 along with various downhole tools, such as one or more logging tools 32. The BHA 28 may thus convey the one or more logging tools 32 through the geological region 14 via the borehole 12. As described in greater detail herein, the one or more logging tools 32 may be any suitable downhole tool that emits electromagnetic waves within the borehole 12 (e.g., a downhole environment). The downhole tools, which may include the one or more logging tools 32, may collect a variety of information relating to the geological region 14 and the state of drilling in the borehole 12. For instance, the downhole tools may be logging-while drilling (LWD) tools that measure physical properties of the geological region 14, such as density, porosity, resistivity, lithology, and so forth. Likewise, the downhole tools may be measurement-while-drilling (MWD) tools that measure certain drilling parameters, such as the temperature, pressure, orientation of the drill bit 30, mapping-while-drilling tools, and so forth.

The one or more logging tools 32 may receive energy from an electrical energy device or an electrical energy storage device, such as an auxiliary power source 34 or another electrical energy source to power the tool. In some embodiments, the one or more logging tools 32 may include a power source within the one or more logging tools 32, such as a battery system or a capacitor, to store sufficient electrical energy to emit and/or receive electromagnetic waves.

Communications 36, such as control signals, may be transmitted from a data processing system 38 (processing system 38) to the one or more logging tools 32, and communications 36, such as data signals related to the results/measurements of the one or more logging tools 32, may be returned to the data processing system 38 from the one or more logging tools 32. The data processing system 38 may be any electronic data processing system that can be used to carry out the systems and methods of this disclosure. For example, the data processing system 38 may include one or more processors 40, which may execute instructions stored in memory 42 and/or storage 44. The memory 42 and/or the storage 44 of the data processing system 38 may be any suitable article of manufacture that can store the instructions. In certain embodiments, the one or more processors 40 may include a microprocessor, a microcontroller, a processor module or subsystem, a programmable integrated circuit, a programmable gate array, a digital signal processor (DSP), or another control or computing device. In certain embodiments, the one or more processors 40 may include machine learning (ML) and/or artificial intelligence (AI) based processors, such as neural processing units (NPUs). Likewise, the one or more processors 40 may operate to implement a trained ML model as part of an AI processing system.

In certain embodiments, the memory 42 and storage 44 are implemented as one or more non-transitory computer-readable or machine-readable storage media. In certain embodiments, the memory 42 may include one or more different forms of memory, including semiconductor memory devices, such as dynamic or static random access memories (DRAMs or SRAMs), erasable and programmable read-only memories (EPROMs), electrically erasable and programmable read-only memories (EEPROMs) and flash memories. The storage 44 may include solid state drives, magnetic disks such as fixed, floppy and removable disks; other magnetic media including tape; optical media such as compact disks (CDs) or digital video disks (DVDs); or other types of storage devices. Note that the computer-executable instructions and associated data of the analysis module(s) may be provided on one computer-readable or machine-readable storage medium of the memory 42 or the storage 44, or alternatively, may be provided on multiple computer-readable or machine-readable storage media distributed in a large system having possibly plural nodes. Such computer-readable or machine-readable storage medium or media are considered to be part of an article (or article of manufacture), which may refer to any manufactured single component or multiple components. In certain embodiments, the storage 44 may be located either in the machine running the machine-readable instructions or may be located at a remote site from which machine-readable instructions may be downloaded over a network for execution.

As illustrated, the data processing system 38 may optionally also include a display 46, which may be any suitable electronic display, and may display images generated by the processor 40. The data processing system 38 may be a local component of the drilling system 10 (i.e., at the surface), within the one or more logging tools 32 (i.e., downhole), a device located proximate to the drilling operation, and/or a remote data processing device located away from the drilling system 10 to process downhole measurements in real time or sometime after the data has been collected. In some embodiments, the data processing system 38 may be a portable computing device (e.g., tablet, smart phone, or laptop) or a server remote from the drilling system 10. In some embodiments, the one or more logging tools 32 may store and process collected data in the BHA 28 or send the data to the surface for processing via communications 36 described above, including any suitable telemetry (e.g., electrical signals pulsed through the geological region 14 or mud pulse telemetry using the drilling fluid).

It should be noted that, although the discussion above relates to a drilling system, other downhole equipment or systems may employ the systems and methods of this disclosure. For example, a downhole tool with an acoustic tool conveyed by slickline, coiled tubing, wireline, or other delivery systems, may utilize the disclosed systems and methods.

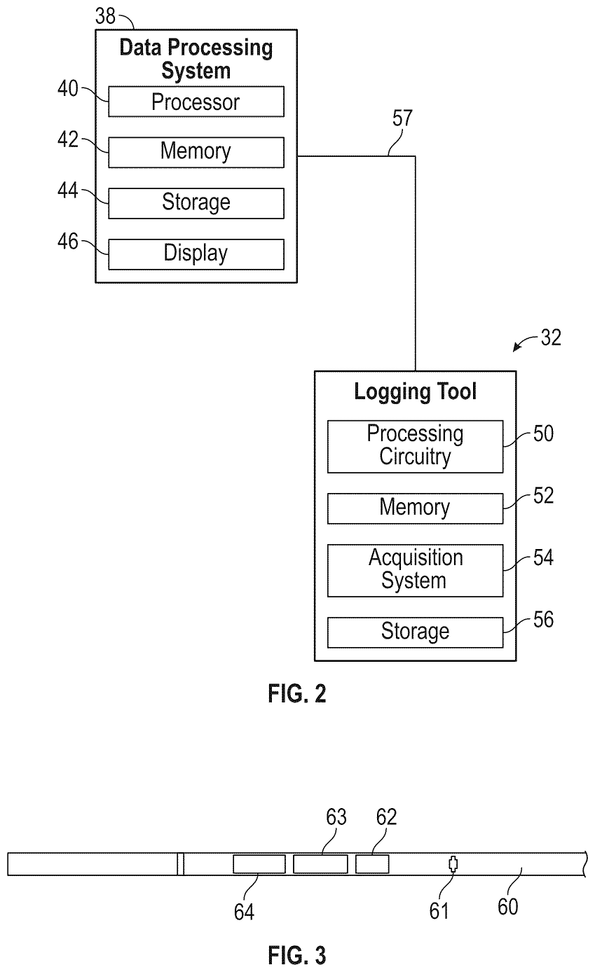

In one embodiment, operation of drilling system 10 may be controlled by a processor of the data processing system 38. For example, FIG. 2 illustrates a block diagram of the data processing system 38 that is communicatively coupled to the one or more logging tools 32. In the illustrated embodiment, a logging tool 32 includes processing circuitry 50, memory 52, an acquisition system 54, and storage 56. In some embodiments, the processing circuitry 50 may include an ASIC (application specific integrated circuit), field programmable gate array (FPGA), a micro control unit (MCU), a digital signal processor (DSP), and the like that operate on high integer value data (e.g., having 16-bit resolution, 32-bit resolution, 64-bit resolution, etc.). In some embodiments, the logging tool 32 communicates with the data processing system 38 via a data cable 57, telemeter, or other suitable techniques. For example, the logging tool 32 may communicate measurements obtained by a one or more sensors (or meters) as part of the acquisition system 54. In turn, a processor 40 of the surface control system may determine certain parameters (e.g., porosity, water saturation, permeability, velocities, resistivity, and so forth) based on the measurements. In such embodiments, the acquisition system 54 may include an emission source (e.g., an antenna) to acquire, obtain, or otherwise measure measurements.

FIG. 3 illustrates an example of a nuclear logging tool 58 that can be utilized as the logging tool 32. The nuclear logging tool 58 (e.g., nuclear tool 58), as illustrated, includes a pulsed neutron generator as a transmitter 60 that operates to generate high -energy neutrons. The nuclear logging tool 58 additionally includes a detector 61 disposed along the nuclear tool 58. Detector 61 can include, for example, a compact neutron monitor that is sensitive to fast neutrons. Detectors 62 and detector 63 can be additionally disposed along the nuclear logging tool 58. Detector 62 can be a near detector and detector 63 can be a far detector. Detector 62 and detector 63 can be scintillators, for example, cerium-doped lanthanum bromide (LaBr3:Ce) scintillators. The nuclear logging tool 58 can additionally include a detector 64 as a deep detector, for example, a yttrium aluminum perovskite (YAP) scintillator. The nuclear logging tool 58 can be utilized in conjunction with a multifunction spectroscopy service by pairing the multiple detectors 61, 62, 63, and 64 with a high-output pulsed neutron generator (as transmitter 60) to provide stand-alone cased hole formation evaluation and reservoir saturation monitoring—all in a single tool 58. While a nuclear logging tool 32 is represented in FIG. 3, it should be noted that the present techniques can be applied to other logging tools, including nuclear magnetic resonance tools, gamma ray logging tools, electromagnetic tools, and other types of logging tools.

Returning to FIG. 2, in certain embodiments, the data processing system 38 may include one or more analysis modules (e.g., a program of computer-executable instructions and associated data) that may be configured to perform various functions of the embodiments described herein. In certain embodiments, to perform these various functions, the one or more analysis modules may be executed on one or more processors 40 of the data processing system 38, which may be connected to memory 42 and storage 44 in which the one or more analysis modules may be stored.

In certain embodiments, the computer-executable instructions of the one or more analysis modules, when executed by the one or more processors 40, may cause the one or more processors 40 to generate one or more models (e.g., forward model, inverse model, mechanical model, and so forth). Such models may be used by the processing system 38 to predict values of operational parameters that may or may not be measured (e.g., using gauges, sensors, and so forth) during well operations.

One technique for generation of the models for a formation by the processing system may include acquiring data via the logging tool 32 and transmitting that data to the processing system 38 for interpretation. This interpretation of the measured data by the processing system 38 can include performance of an inversion by the processing system 38 in which measured data received from the logging tool 32 is utilized to infer a parameter to be calculated using a forward model. This can include iteration utilizing the forward model until a difference (or error) between a measured data and the parameter being estimated to generate an output is minimized (or is less than a predetermined threshold value).

That is, the formation evaluation data resulting from measurements collected by the logging tools can be used, for example, in well planning and/or to implement various physical actions, for example, in generation of control signals for equipment used in natural resource operations, such as drilling operations, production operations, and the like. Well planning may include, for example, determining a wellbore trajectory, determining casing placement, determining completions, predicting potential drilling risks, designing sections, determining drilling fluids, etc. Drilling control may include, for example, steering a drill, varying one or more operational parameters of the drill during drilling, optimizing drilling parameter settings, etc. Other suitable uses of formation evaluation data can include uses associated with various stages of reservoir exploration, development and/or production. for use, for example, in generation of control signals for equipment used in natural resource operations, such as drilling operations, production operations, and the like. As will be discussed in greater detail below, the generation of the interpretation results (e.g., characterizing a formation) by the data processing system 38 can be performed using a trained ML in real-time or in near-real time.

One technique for the processing of the measurement data taken in conjunction with a geosteering process or operation involves implementing an inversion operation on the measured data, for example, to determine a position of a wellbore with respect to layer boundaries in earth formations. Inversions (inversion operations), thus, can be utilized in geosteering to interpret formation data in real-time while drilling. This allows users to adjust the drilling trajectory to optimize production, reduce risks, etc. In practice, logging tools take measurements that are applied to an inversion process that operates to generate a mapping of a reservoir. This mapping, as noted above, can be used in the geosteering process to make informed decisions about the geological formations.

Use of a trained ML model for implementation of the inversion operation can require substantially less computation resources and time than traditional inversion methods (e.g., utilizing a Gauss-Newton method or the like). However, the results generated by the trained ML model (when performing inversion methods and/or other formation characterization operations) vary greatly based upon the manner in which the ML model has been trained.

Recent advances in deep learning have paved the way for more robust formation evaluation methods. In one embodiment, the ML model herein can be trained via transfer learning, which allows the ML model to be trained on simulated and/or laboratory data. The trained ML model then adapts thereafter to efficiently to real-world field data. This approach reduces the cost and effort associated with gathering extensive field measurements while ensuring high model accuracy. However, other techniques for training of the ML model are additionally envisioned.

In conjunction with another technique, a data-augmentation balancing technique is provided to transfer learning by the ML model between controlled (simulations, lab, etc.) and field datasets. This allows for calibrating lab measurements with realistic tool measurements from the field. In some embodiments, this can include freezing of a physics learned model and adding extra layers in the ML model to transform uncalibrated modeled data to generate calibrated measurements feeding into the predictive model to generate quantities of interest (QoI) predictions. Additionally, the ML model can operate to learn tool calibrations shifts in conjunction with an additional freeze to provide better calibrated QoI predictions from arbitrary tool measurements, since the frozen model has captured maximally generalizable physics (e.g., from synthetic data). Data-mixing based implicit transfer learning is not utilized or proposed calibration shifts are learned implicitly during optimization of learning QoI predictions. Model training for learning missing tool modeling shifts (both from low-fidelity to high-fidelity and vice versa) ensures generalizability, is provided. That is, present embodiments provide a data-mixing based ML/DL method to generalize controlled lab measurements applications to field data and a methodology using simplified model training to generate high-fidelity tool measurements and interpret tool measurements using learnings from supposedly low-fidelity but generalizable modeling databases.

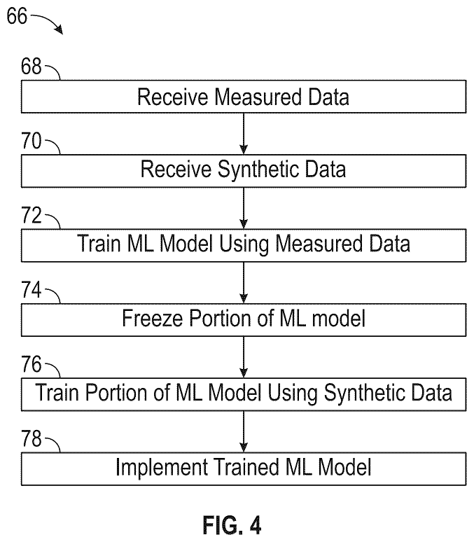

FIG. 4 illustrates a flow chart 66 illustrating one technique for training and utilization of a ML model implemented in the data processing system 38 as well as the use of the trained ML model to generate QoI from measured data received from, for example, a logging tool 32. This QoI that is generated can be used in generation of, for example, formation evaluation data resulting from measurements collected by one or more logging tools 32. Moreover, while the blocks of flow chart 66 are illustrated in a particular order, it should be noted that some of the blocks can be performed in a different order and/or concurrently with one another.

In block 68, measured data can be received by a computing system (e.g., the data processing system 38 or a similar computing system that can be directly or indirectly coupled to the data processing system 38 via, for example, a network connection). This measured data can correspond to field data (i.e., physical measurements acquired under operational real-world conditions). This field data can be measured or otherwise acquired, for example, from one or more wells having similar geological properties to the geological region 14 into which a borehole 12 is being drilled, operated on, etc. However, it should be noted that from a practical perspective, field data may not be able to account for all possible formation types, environmental effects, etc. Accordingly, training the ML model on the field data alone may lead to a less robust ML model.

As such, additional measured data can be received in block 68 for use in the training of the ML model to provide additional data from which to train the ML model. In some embodiments, the additional measured data received in block 68 corresponds to lab data. Lab data, for example, is acquired under controlled settings/controlled environments (e.g., lab settings). The lab data, while representing actual measured data, is not exposed to environmental factors, operating factors, etc. present in real-world data collection environments (e.g., conditions under which field data is measured). Accordingly, while lab data does provide additional data inputs for the training of the ML model, the lab data tends not to account for field data related variations, for example, changes in logging speeds, weak motional emf effects in electromagnetic tools, road noise in logging tools, complex and unknown lithology formations etc. Thus, use of lab data alone would tend to benefit from ‘tuning-in’ or otherwise accounting for realistic (e.g., real-world) variations when training the ML model.

While field data and lab data (e.g., measured data) can be used in the training of the ML model, the robustness of the ML model can be improved when additional amounts of data are provided as training data. However, obtaining measured data can be expensive, time-consuming, or otherwise difficult to collect. Accordingly, in some embodiments, use of synthetic data can also be undertaken as training data for the ML model. In block 70, synthetic data is received. This synthetic data is artificial data generated by a computing system (e.g., data processing system 38 or another computing system) and provided to the ML model in conjunction with block 70.

Synthetic modeling-based data generating processes are typically used to aid in generalizing the application of machine and deep learning models. Advantages are that hundreds, thousands, or even more datasets can be generated with relative less cost and complexity than gathering a similar number of measured datasets. However, due to the limitations of the modeling process or the complexity of the real-world tool measurements, these synthetically generated responses typically have limitations in that they are not generally useful in direct training of an ML model to accurately predict real, tool dataset acquired in lab or in the field, or in transfer learning from already calibrated data.

In some embodiments, use of the received measured data in block 68 as well as the received synthetic data in block 70 in training of the ML model can operate to provide a full operational envelop of the logging tool 32. can only be captured through low-cost synthetic data generating processes (assuming they are highly scalable numerical/analytical methods). Techniques for the training of the ML model are described herein.

In block 72, the ML model can be trained using the received measured data from block 68. In one embodiment, training of the ML model in block 72 can be undertaken only using field data to train the ML model to predict a QoI. However, this can lead to a trained ML model that learns to predict QoI within the range of inputs (tool measurements) and outputs (QoI) it was exposed to during the training. When this model is then exposed to a lab-measured dataset with a more diverse data spanning over a much larger range of inputs and outputs, it fails to ‘extrapolate’ beyond its learned capabilities and tends to produce poor predictions.

Thus, in some embodiments, to expand the application of the ML model beyond field datasets, lab datasets are used in the training in block 72. For example, transfer learning techniques in conjunction with block 72 where the lab-data trained ML model is later exposed to field data for additional training (i.e. using initially learned model weights and biases that are updated to account for field variations). However, it has been noted that training the ML model in this manner can sometimes lead to reductions in accuracy when the trained model is tested with field data, as the weights have not accounted for the variations common to field data.

Accordingly, in some embodiments, a transfer learning technique is applied in block 72 to address the aforementioned issues. For example, both the lab and the field datasets (as measured data) are used concurrently in the training phase of the deep-learning model (i.e., the ML model). That is, instead of serially providing lab datasets, then field datasets to train the ML model or serially providing field datasets, then lab datasets to train the ML model, measured data including both the lab datasets and the field datasets are provided in parallel (i.e., concurrently) as training data to train the ML model in block 72. In conjunction with this training process, the ML model learns not only the correct mapping of the measurement set coming from lab datasets and field datasets, but also the inherent calibration shifts and anomalies inherent in the field dataset.

In some embodiments, in conjunction with the training of the ML model in block 72 using a mixed training dataset (inclusive of both lab datasets and field datasets), predetermined weighting value(s) can be provided to weigh the lab datasets and the field datasets with respect to one another. For example, when high-fidelity lab measurements (D_{L}) and low-fidelity field measurements (D_{F}) can be provided as training data to the ML model during the training phase of block 72 using the following equation:

D_{training}=D_{L}+α·D_{F} (Equation 1)

In conjunction with Equation 1, D_{training} represents the data training set provided to the ML model in conjunction with block 72, D_{L} represents the lab measurements (lab datasets), D_{F} represents the field measurements (field data), and α represents is a selectable scalar value which, for example, controls the contribution of the field datasets into the model parameter space. In some embodiments, α can be approximately, for example, 0.05 (i.e., 5%), 0.10 (i.e., 10%), 0.15 (i.e., 15%), 0.20 (i.e., 20%), 0.25 (i.e., 25%), 0.30 (i.e., 30%), or another value. Similarly, α can be selected to be approximately between, for example, 0.05 (i.e., 5%) and 0.10 (i.e., 10%), 0.10 (i.e., 10%) and 0.20 (i.e., 20%), 0.20 (i.e., 20%) and 0.30 (i.e., 30%), or another range. By providing weightings of the relative value of the input datasets in conjunction with Equation 1, deteriorating in QoI predictions from the lab-data and the field-data can be minimized.

As previously noted, synthetic data received in block 70 can be useful in training ML models. However, when using synthetic data alone to initially train the ML model, the resultant trained ML model may not be able to adequately capture higher order tool responses or higher levels of complexity in underlying measurement physics. Indeed, if only utilizing synthetic data from block 70 in ML model training, for scenarios where higher order models may defray shortcomings of linear models which fail to capture tool non-linearities (e.g. non-linear magnetic cores), for complex tool physics, like nuclear simulations, or non-linear higher order couplings of the tool non-linear cores with surrounding non-linear media, the trained ML model may never be able to capture the full physics of the problems

To alleviate these instances, present embodiments design and utilize a calibration model as a pre-processing model, which internally learns the linear, non-linear, and higher order mathematical rotations, (i.e., shifts which a synthetically trained model may not capture). This can be accomplished using the lab data and field data trained ML model from block 72 as an anchor model. The premise is that the model has already learned the real-tool space transformation of tool measurements to QoI, i.e., it has learned the governing tool physics behind prediction of the QoI from the tool measurements. Thus, given the correct tool measurements the model correctly predicts the QoI.

For such instances, an underlying universal approximation theorem applicable to ML/DL methods can be utilized. This can include design and utilization of a calibration model as a pre-processing model, which internally learns the linear, non-linear, and higher order mathematical rotations (i.e., shifts which a synthetic data trained ML model may not be able to capture). In practice, this can include utilization of the lab data and field data trained ML model from block 72 as an anchor model. This is reflected in block 74, whereby the trained ML model from block 72 is frozen (i.e., additional training data provided to the ML model will not be provided to predetermined portions of the ML model). That is, in block 74, the isolation of predetermined layers of the ML architecture (i.e., layers of a neural network) is undertaken so that those layers are not additionally trained with subsequently provided training data. That is, the ML model has already learned the real-tool space transformation of tool measurements to QoI, i.e., it has learned the governing tool physics behind prediction of the QoI from the tool measurements in block 72. Thus, the ML model in block 74, when provided correct tool measurements, correctly predicts the QoI.

During training the labels for the QoI are known for the synthetically generated simulations (synthetic data). So, the only missing piece of information is the higher order couplings and missed modeling parameters in the synthetic models. In other words, the objective is to use synthetically generated data received in block 70 to learn the missing model components that otherwise are not captured to correctly reproduce QoI for synthetically generated responses as data passes through the frozen ML model of block 74. This process is implemented in conjunction with block 76. In the process of the training in block 76, in some embodiments, the simplest and smallest possible model is trained to ensure model over-fitting is avoided. This is ensured both from model architecture and data usage perspective. That is, the selection of the portion of the model architecture that is unfrozen can be chosen to be of a desired size. In some embodiments, 1 or 2 layers of 16 neurons each with a 10-30% training-to-testing split can be chosen as the unfrozen portion of the neural network (i.e., layers of the neural network).

That is, in conjunction with block 76, a smallest and simplest possible model is trained on 10-30% of synthetic datasets while the weights are frozen for well-established machine learning model (trained on lab and field measurements for reliable QoI predictions). Once, the model is trained with this selected portion of the synthetic datasets, the calibration shifts, rotations, and higher order non-linearities are now embedded in the first pre-processing layers of the ML architecture and the remaining 70-90% synthetic testing dataset is passed through this new network. This technique operates to better reproduce true QoI predictions by the ML model.

Thereafter, the ML model (having been trained on both measured data from block 68 and synthetic data from block 70 in the manner described above) can be implemented. This implementation can include, for example, exporting the trained ML model to a compiler program, where it is formatted. Compilation is undertaken via the compiler program to allow for the ML model to be deployed in the data processing system 38 in block 78. That is, the ML model can be deployed to the data processing system 38 to be utilized in conjunction with the processor 40 and/or an NPU of the data processing system 38, for example, as a trained neural network. In this manner, blocks 68-76 of flow chart 66 can be performed remotely from the data processing system 38 and the trained ML model can be loaded onto the data processing system 38 in block 78 to be used in conjunction with natural resource operations.

For example, in conjunction with block 78, formation evaluation data resulting from measurements collected by the logging tools 32 can be performed via the data processing system 38 utilizing the ML model loaded thereon. In this manner, the ML model operating on the data processing system 38 performs formation evaluations based on the received measurement data from logging tools 32 and operates to provide well planning and/or to implement various physical actions, for example, in generation of control signals for equipment used in natural resource operations, such as drilling operations, production operations, and the like based upon the formation evaluations. Well planning may include, for example, determining a wellbore trajectory, determining casing placement, determining completions, predicting potential drilling risks, designing sections, determining drilling fluids, etc. Drilling control may include, for example, steering a drill, varying one or more operational parameters of the drill during drilling, optimizing drilling parameter settings, etc. Other suitable uses of formation evaluation data can include uses associated with various stages of reservoir exploration, development and/or production. for use, for example, in generation of control signals for equipment used in natural resource operations, such as drilling operations, production operations, and the like in conjunction with block 78.

It should be noted that the flow chart 66 of FIG. 4 illustrates one technique to train a ML model and implement that trained ML model, for example, in a data processing system 38. However, other techniques to train and implement the ML model are contemplated.

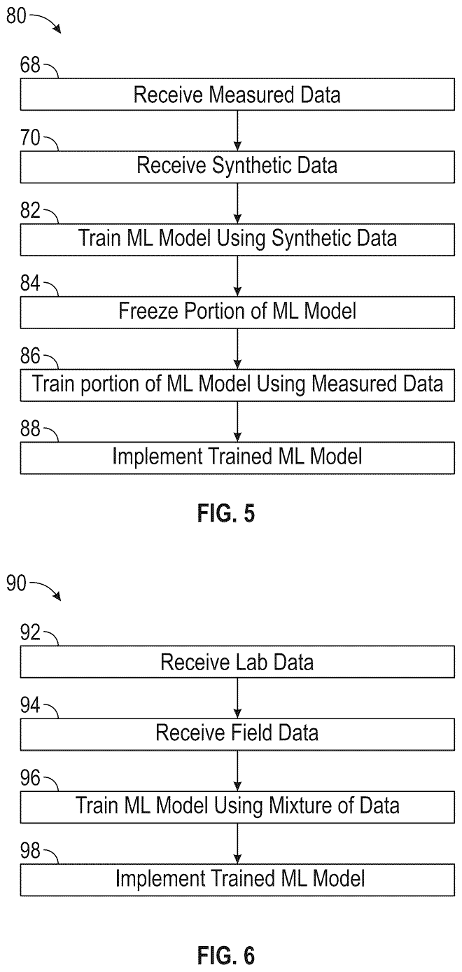

For example, FIG. 5 illustrates a flow chart 80 illustrating another technique for training and utilization of a ML model implemented in the data processing system 38 as well as the use of the trained ML model to generate QoI from measured data received from, for example, a logging tool 32. This QoI that is generated can be used in generation of, for example, formation evaluation data resulting from measurements collected by one or more logging tools 32. Moreover, while the blocks of flow chart 80 are illustrated in a particular order, it should be noted that some of the blocks can be performed in a different order and/or concurrently with one another.

In block 68, measured data can be received by a computing system (e.g., the data processing system 38 or a similar computing system that can be directly or indirectly coupled to the data processing system 38 via, for example, a network connection). This measured data can correspond to field data (i.e., physical measurements acquired under operational real-world conditions). This field data can be measured or otherwise acquired, for example, from one or more wells having similar geological properties to the geological region 14 into which a borehole 12 is being drilled, operated on, etc. However, it should be noted that from a practical perspective, field data may not be able to account for all possible formation types, environmental effects, etc. Accordingly, training the ML model on the field data alone may lead to a less robust ML model.

As such, additional measured data can be received in block 68 for use in the training of the ML model to provide additional data from which to train the ML model. In some embodiments, the additional measured data received in block 68 corresponds to lab data. Lab data, for example, is acquired under controlled settings/controlled environments (e.g., lab settings). The lab data, while representing actual measured data, is not exposed to environmental factors, operating factors, etc. present in real-world data collection environments (e.g., conditions under which field data is measured). Accordingly, while lab data does provide additional data inputs for the training of the ML model, the lab data tends not to account for field data related variations, for example, changes in logging speeds, weak motional emf effects in electromagnetic tools, road noise in logging tools, complex and unknown lithology formations etc. Thus, use of lab data alone would tend to benefit from ‘tuning-in’ or otherwise accounting for realistic (e.g., real-world) variations when training the ML model.

While field data and lab data (e.g., measured data) can be used in the training of the ML model, the robustness of the ML model can be improved when additional amounts of data are provided as training data. However, obtaining measured data can be expensive, time-consuming, or otherwise difficult to collect. Accordingly, in some embodiments, use of synthetic data can also be undertaken as training data for the ML model. In block 70, synthetic data is received. This synthetic data is artificial data generated by a computing system (e.g., data processing system 38 or another computing system) and is provided to the ML model in conjunction with block 70.

Synthetic modeling-based data generating processes are typically used to aid in generalizing the application of machine and deep learning models. Advantages are that hundreds, thousands, or even more datasets can be generated with relative less cost and complexity than gathering a similar number of measured datasets. However, due to the limitations of the modeling process or the complexity of the real-world tool measurements, these synthetically generated responses typically have limitations in that they are not generally useful in direct training of an ML model to accurately predict real, tool dataset acquired in lab or in the field, or in transfer learning from already calibrated data.

In some embodiments, use of the received measured data in block 68 as well as the received synthetic data in block 70 in training of the ML model can operate to provide a full operational envelop of the logging tool 32. In block 82, the ML model can be trained using the received synthetic data from block 70. However, as previously noted, when using synthetic data alone to initially train the ML model, the resultant trained ML model may not be able to adequately capture higher order tool responses or higher levels of complexity in underlying measurement physics. Indeed, if only utilizing synthetic data from block 70 in ML model training in block 82, for scenarios where higher order models may defray shortcomings of linear models which fail to capture tool non-linearities (e.g. non-linear magnetic cores), for complex tool physics, like nuclear simulations, or non-linear higher order couplings of the tool non-linear cores with surrounding non-linear media, the trained ML model may never be able to capture the full physics of the problems.

To alleviate these instances, present embodiments design and utilize a calibration model as a pre-processing model, which internally learns the linear, non-linear, and higher order mathematical rotations, (i.e., shifts which a synthetically trained model may not capture). This can be accomplished using the synthetically trained ML model from block 82 as an anchor model. This is reflected in block 84, whereby the trained ML model from block 82 is frozen (i.e., additional training data provided to the ML model will not be provided to predetermined portions of the ML model). That is, in block 84, the isolation of predetermined layers of the ML architecture (i.e., layers of a neural network) is undertaken so that those layers are not additionally trained with subsequently provided training data.

In this way, the ML model is trained using high-dimensional synthetically or computerized data and then the ML model learns the tool calibrations from the lab data and field data received in block 68. This can be performed in conjunction with block 86, in which the measured data from block 68 is used to learn the missing model components that otherwise are not captured to correctly in the training of the ML model in block 82. In the process of the training in block 86, in some embodiments, the simplest and smallest possible model is trained to ensure model over-fitting is avoided. This is ensured both from model architecture and data usage perspective. That is, the selection of the portion of the model architecture that is unfrozen can be chosen to be of a desired size. In some embodiments, 1 or 2 layers of 16 neurons each with a 10-30% training-to-testing split can be chosen as the unfrozen portion of the neural network (i.e., layers of the neural network).

In some embodiments, in conjunction with the training of the ML model in block 86 uses a mixed training dataset (inclusive of both lab datasets and field datasets), whereby predetermined weighting value(s) can be provided to weigh the lab datasets and the field datasets with respect to one another. For example, the mixed training dataset can be selected in conjunction with Equation 1 previously discussed. In this manner, both the lab and the field datasets (as measured data) are used concurrently in the training phase of the ML model in conjunction with block 86. That is, instead of serially providing lab datasets then field datasets to train the ML model or serially providing field datasets then lab datasets to train the ML model, measured data including both the lab datasets and the field datasets are provided in parallel (i.e., concurrently) as training data to train the ML model in block 86. In conjunction with this training process, the ML model learns not only the correct mapping of the measurement set coming from lab datasets and field datasets, but also the inherent calibration shifts and anomalies inherent in the field dataset.

In conjunction with block 86, a smallest and simplest possible model is trained on 10-30% of the measured datasets while the weights are frozen for well-established machine learning model (trained on synthetic measurements for reliable QoI predictions). Once the model is trained with this selected portion of the measured datasets, the calibration shifts, rotations, and higher order non-linearities are now embedded in the first pre-processing layers of the ML architecture and the remaining 70-90% measured testing dataset is passed through this new network. This technique operates to better reproduce true QoI predictions by the ML model.

Thereafter, the ML model (having been trained on both measured data from block 68 and synthetic data from block 70 in the manner described above) can be implemented. This implementation can include, for example, exporting the trained ML model to a compiler program, where it is formatted. Compilation is undertaken via the compiler program to allow for the ML model to be deployed in the data processing system 38 in block 88. That is, the ML model can be deployed to the data processing system 38 to be utilized in conjunction with the processor 40 and/or an NPU of the data processing system 38 for example, as a trained neural network. In this manner, blocks 68, 70, 82, 84, and 86 of flow chart 80 can be performed remotely from the data processing system 38 and the trained ML model can be loaded onto the data processing system 38 in block 88 to be used in conjunction with natural resource operations.

For example, in conjunction with block 88, formation evaluation data resulting from measurements collected by the logging tools 32 can be performed via the data processing system 38 utilizing the ML model loaded thereon. In this manner, the ML model operating on the data processing system 38 performs formation evaluations based on the received measurement data from logging tools 32 and operates to provide well planning and/or to implement various physical actions, for example, in generation of control signals for equipment used in natural resource operations, such as drilling operations, production operations, and the like based upon the formation evaluations. Well planning may include, for example, determining a wellbore trajectory, determining casing placement, determining completions, predicting potential drilling risks, designing sections, determining drilling fluids, etc. Drilling control may include, for example, steering a drill, varying one or more operational parameters of the drill during drilling, optimizing drilling parameter settings, etc. Other suitable uses of formation evaluation data can include uses associated with various stages of reservoir exploration, development and/or production. for use, for example, in generation of control signals for equipment used in natural resource operations, such as drilling operations, production operations, and the like in conjunction with block 88.

FIG. 6 illustrates a flow chart 90 illustrating another technique for training and utilization of a ML model implemented in the data processing system 38 as well as the use of the trained ML model to generate QoI from measured data received from, for example, a logging tool 32, in conjunction with some embodiments. This QoI that is generated can be used in generation of, for example, formation evaluation data resulting from measurements collected by one or more logging tools 32. Moreover, while the blocks of flow chart 90 are illustrated in a particular order, it should be noted that some of the blocks can be performed in a different order and/or concurrently with one another.

In block 92, lab data can be received by a computing system (e.g., the data processing system 38 or a similar computing system that can be directly or indirectly coupled to the data processing system 38 via, for example, a network connection). This lab data can be received in block 92 for use in the training of the ML model to provide additional data from which to train the ML model. As previously discussed, lab data, for example, is acquired under controlled settings/controlled environments (e.g., lab settings). The lab data, while representing actual measured data, is not exposed to environmental factors, operating factors, etc. present in real-world data collection environments (e.g., conditions under which field data is measured). Accordingly, while lab data does provide additional data inputs for the training of the ML model, the lab data tends not to account for field data related variations, for example, changes in logging speeds, weak motional emf effects in electromagnetic tools, road noise in logging tools, complex and unknown lithology formations etc. Thus, use of lab data alone would tend to benefit from ‘tuning-in’ or otherwise accounting for realistic (e.g., real-world) variations when training the ML model.

Accordingly, in block 94, field data can be received by a computing system (e.g., the data processing system 38 or a similar computing system that can be directly or indirectly coupled to the data processing system 38 via, for example, a network connection). The field data can include physical measurements acquired under operational real-world conditions. This field data can be measured or otherwise acquired, for example, from one or more wells having similar geological properties to the geological region 14 into which a borehole 12 is being drilled, operated on, etc. However, it should be noted that from a practical perspective, field data may not be able to account for all possible formation types, environmental effects, etc. Accordingly, training the ML model on the field data alone may lead to a less robust ML model. However, using the field data from block 94 and the lab data from block 92 may increase the robustness of the ML model.

In block 96, the ML model can be trained using the received lab data from block 92 and the received field data from block 94 as a mixture of data. In one embodiment, training of the ML model in block 96 using a mixture of data (i.e., lab data and field data) data to train the ML model to predict a QoI. By using a mixture of data in block 96, the application of the ML model is expanded. In some embodiments, a transfer learning technique is applied in block 96 whereby both the lab and the field datasets (as measured data from block 92 and block 94) are used concurrently in the training phase of the deep-learning model (i.e., the ML model). That is, instead of serially providing lab datasets, then field datasets to train the ML model or serially providing field datasets, then lab datasets to train the ML model, measured data including both the lab datasets and the field datasets are provided in parallel (i.e., concurrently) as training data to train the ML model in block 96. In conjunction with this training process, the ML model learns not only the correct mapping of the measurement set coming from lab datasets and field datasets, but also the inherent calibration shifts and anomalies inherent in the field dataset.

In some embodiments, in conjunction with the training of the ML model in block 96 using a mixed training dataset (inclusive of both lab datasets and field datasets), predetermined weighting value(s) can be provided to weigh the lab datasets and the field datasets with respect to one another. For example, when high-fidelity lab measurements (D_{L}) and low-fidelity field measurements (D_{F}) can be provided as training data to the ML model during the training phase of block 96 using Equation 1, reprinted below:

D_{training}=D_{L}+α·D_{F} (Equation 1)

In conjunction with Equation 1, D_{training} represents the data training set provided to the ML model in conjunction with block 96, D_{L} represents the lab measurements (lab datasets), D_{F} represents the field measurements (field data), and α represents is a selectable scalar value which, for example, controls the contribution of the field datasets into the model parameter space. In some embodiments, α can be approximately, for example, 0.05 (i.e., 5%), 0.10 (i.e., 10%), 0.15 (i.e., 15%), 0.20 (i.e., 20%), 0.25 (i.e., 25%), 0.30 (i.e., 30%), or another value. Similarly, α can be selected to be approximately between, for example, 0.05 (i.e., 5%) and 0.10 (i.e., 10%), 0.10 (i.e., 10%) and 0.20 (i.e., 20%), 0.20 (i.e., 20%) and 0.30 (i.e., 30%), or another range. By providing weightings of the relative value of the input datasets in conjunction with Equation 1, deteriorating in QoI predictions from the lab-data and the field-data can be minimized.

Training of the ML model in block 96 can result in a trained model having learned the real-tool space transformation of tool measurements to QoI, i.e., it has learned the governing tool physics behind prediction of the QoI from the tool measurements. Thus, given the correct tool measurements, the model correctly predicts the QoI. Thereafter, the ML model (having been trained in block 96 on the received lab data from block 92 and the received field data from block 94) in the manner described above can be implemented in block 98. This implementation in block 98 can include, for example, exporting the trained ML model to a compiler program, where it is formatted. Compilation is undertaken via the compiler program to allow for the ML model to be deployed in the data processing system 38 in block 98. That is, the ML model can be deployed to the data processing system 38 to be utilized in conjunction with the processor 40 and/or an NPU of the data processing system 38, for example, as a trained neural network. In this manner, blocks 92-96 of flow chart 90 can be performed remotely from the data processing system 38 and the trained ML model can be loaded onto the data processing system 38 in block 96 to be used in conjunction with natural resource operations.

For example, in conjunction with block 98, formation evaluation data resulting from measurements collected by the logging tools 32 can be performed via the data processing system 38 utilizing the ML model loaded thereon. In this manner, the ML model operating on the data processing system 38 performs formation evaluations based on the received measurement data from logging tools 32 and operates to provide well planning and/or to implement various physical actions, for example, in generation of control signals for equipment used in natural resource operations, such as drilling operations, production operations, and the like based upon the formation evaluations. Well planning may include, for example, determining a wellbore trajectory, determining casing placement, determining completions, predicting potential drilling risks, designing sections, determining drilling fluids, etc. Drilling control may include, for example, steering a drill, varying one or more operational parameters of the drill during drilling, optimizing drilling parameter settings, etc. Other suitable uses of formation evaluation data can include uses associated with various stages of reservoir exploration, development and/or production. for use, for example, in generation of control signals for equipment used in natural resource operations, such as drilling operations, production operations, and the like in conjunction with block 98.

The subject matter described in detail above may be defined by one or more clauses, as set forth below.

A method includes receiving first data, receiving second data, training a machine learning (ML) model of a neural network utilizing training data based upon the first data to generate a first trained ML model, isolating a first set of layers of the neural network from a second set of layers of the neural network, training a portion of the first trained ML model of the second set of layers of the neural network utilizing the second data to generate a fully trained ML model, and deploying the fully trained ML model on a data processing system to interpret received measurements collected in conjunction with a natural resource operation.

The method of the preceding clause, wherein receiving the first data comprises receiving physically measured data as the first data.

The method of any of the preceding clauses, wherein receiving the physically measured data as the first data comprises receiving field data measured during natural resource operations as a first portion of the first data and receiving lab data measured in conjunction with a controlled environment as a second portion of the first data.

The method of any of the preceding clauses, including generating the training data, using underlying physics, by applying a predetermined ratio or an additive factor of the first portion of the first data with respect to the second portion of the first data.

The method of any of the preceding clauses, wherein receiving the second data comprises receiving synthetically generated data as the second data.

The method of any of the preceding clauses, wherein receiving the first data comprises receiving synthetically generated data as the first data.

The method of any of the preceding clauses, wherein receiving the second data comprises receiving physically measured data as the second data.

The method of any of the preceding clauses, wherein receiving the physically measured data as the second data comprises receiving field data measured during natural resource operations as a first portion of the second data and receiving lab data measured in conjunction with a controlled environment as a second portion of the second data.

The method of any of the preceding clauses, including applying a predetermined ratio of the first portion of the second data with respect to the second portion of the second data as the second data utilized to train the portion of the first trained ML model of the second set of layers of the neural network.

A tangible and non-transitory machine readable medium including instructions to cause processing circuitry to receive first data, receive second data, train a machine learning (ML) model of a neural network utilizing training data based upon the first data to generate a first trained ML model, isolate a first set of layers of the neural network from a second set of layers of the neural network, train a portion of the first trained ML model of the second set of layers of the neural network utilizing the second data to generate a fully trained ML model, and deploy the fully trained ML model on a data processing system to interpret received measurements collected in conjunction with a natural resource operation.

The tangible and non-transitory machine readable medium of the preceding clause, wherein the instructions further cause the processing system to receive the first data as comprising a first portion of the first data comprising field data measured during natural resource operations and as comprising a second portion of the first data comprising lab data measured in conjunction with a controlled environment.

The tangible and non-transitory machine readable medium of any preceding clause, wherein the instructions further cause the processing circuitry to generate the training data by applying a predetermined ratio of the first portion of the first data with respect to the second portion of the first data.

The tangible and non-transitory machine readable medium of any preceding clause, wherein the instructions further cause the processing circuitry to receive the second data as synthetically generated data.

The tangible and non-transitory machine readable medium of any preceding clause, wherein the instructions further cause the processing circuitry to receive the first data as synthetically generated data.

The tangible and non-transitory machine readable medium of any preceding clause, wherein the instructions further cause the processing circuitry to receive the second data as comprising a first portion of the second data comprising field data measured during natural resource operations and as comprising a second portion of the second data comprising lab data measured in conjunction with a controlled environment.

The tangible and non-transitory machine readable medium of any preceding clause, wherein the instructions further cause the processing circuitry to apply a predetermined ratio of the first portion of the second data with respect to the second portion of the second data as the second data utilized to train the portion of the first trained ML model of the second set of layers of the neural network.

A method including receiving first data, receiving second data, training a machine learning (ML) model of a neural network utilizing training data comprising a mixture of the first data and the second data to generate a fully trained ML model, and deploying the fully trained ML model on a data processing system to interpret received measurements collected in conjunction with a natural resource operation.

The method of the preceding clause, including generating the mixture of the first data and the second data via providing a weighting of a relative value of the first data with respect to the second data in generating the mixture of the first data and the second data.

The method of any of the preceding clauses, wherein receiving the first data comprises receiving field data measured during natural resource operations.

The method of any of the preceding clauses, wherein receiving the second data comprises receiving lab data measured in conjunction with a controlled environment as a second portion of the first data.

This written description uses examples to disclose the subject matter, including the best mode, and also to allow any person skilled in the art to practice the subject matter, including making and using any devices or systems and performing any incorporated methods. The patentable scope of the subject matter is defined by the claims and may include other examples that occur to those skilled in the art. Such other examples are intended to be within the scope of the claims if they have structural elements that do not differ from the literal language of the claims, or if they include equivalent structural elements with insubstantial differences from the literal language of the claims.

The techniques presented and claimed herein are referenced and applied to material objects and concrete examples of a practical nature that demonstrably improve the present technical field and, as such, are not abstract, intangible, or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

What is claimed is:

1. A method, comprising:
receiving first data;
receiving second data;
training a machine learning (ML) model of a neural network utilizing training data based upon the first data to generate a first trained ML model;
isolating a first set of layers of the neural network from a second set of layers of the neural network;
training a portion of the first trained ML model of the second set of layers of the neural network utilizing the second data to generate a fully trained ML model; and
deploying the fully trained ML model on a data processing system to interpret received measurements collected in conjunction with a natural resource operation.

2. The method of claim 1, wherein receiving the first data comprises receiving physically measured data as the first data.

3. The method of claim 2, wherein receiving the physically measured data as the first data comprises receiving field data measured during natural resource operations as a first portion of the first data and receiving lab data measured in conjunction with a controlled environment as a second portion of the first data.

4. The method of claim 3, comprising generating the training data, using underlying physics, by applying a predetermined ratio or an additive factor of the first portion of the first data with respect to the second portion of the first data.

5. The method of claim 2, wherein receiving the second data comprises receiving synthetically generated data as the second data.

6. The method of claim 1, wherein receiving the first data comprises receiving synthetically generated data as the first data.

7. The method of claim 6, wherein receiving the second data comprises receiving physically measured data as the second data.

8. The method of claim 7, wherein receiving the physically measured data as the second data comprises receiving field data measured during natural resource operations as a first portion of the second data and receiving lab data measured in conjunction with a controlled environment as a second portion of the second data.

9. The method of claim 8, comprising applying a predetermined ratio of the first portion of the second data with respect to the second portion of the second data as the second data utilized to train the portion of the first trained ML model of the second set of layers of the neural network.

10. A tangible and non-transitory machine readable medium comprising instructions to cause processing circuitry to:
receive first data;
receive second data;
train a machine learning (ML) model of a neural network utilizing training data based upon the first data to generate a first trained ML model;
isolate a first set of layers of the neural network from a second set of layers of the neural network;
train a portion of the first trained ML model of the second set of layers of the neural network utilizing the second data to generate a fully trained ML model; and
deploy the fully trained ML model on a data processing system to interpret received measurements collected in conjunction with a natural resource operation.

11. The tangible and non-transitory machine readable medium of claim 10, wherein the instructions further cause the processing circuitry to receive the first data as comprising a first portion of the first data comprising field data measured during natural resource operations and as comprising a second portion of the first data comprising lab data measured in conjunction with a controlled environment.

12. The tangible and non-transitory machine readable medium of claim 11, wherein the instructions further cause the processing circuitry to generate the training data by applying a predetermined ratio of the first portion of the first data with respect to the second portion of the first data.

13. The tangible and non-transitory machine readable medium of claim 11, wherein the instructions further cause the processing circuitry to receive the second data as synthetically generated data.

14. The tangible and non-transitory machine readable medium of claim 10, wherein the instructions further cause the processing circuitry to receive the first data as synthetically generated data.

15. The tangible and non-transitory machine readable medium of claim 14, wherein the instructions further cause the processing circuitry to receive the second data as comprising a first portion of the second data comprising field data measured during natural resource operations and as comprising a second portion of the second data comprising lab data measured in conjunction with a controlled environment.

16. The tangible and non-transitory machine readable medium of claim 15, wherein the instructions further cause the processing circuitry to apply a predetermined ratio of the first portion of the second data with respect to the second portion of the second data as the second data utilized to train the portion of the first trained ML model of the second set of layers of the neural network.

17. A method, comprising:
receiving first data;
receiving second data;
training a machine learning (ML) model of a neural network utilizing training data comprising a mixture of the first data and the second data to generate a fully trained ML model; and
deploying the fully trained ML model on a data processing system to interpret received measurements collected in conjunction with a natural resource operation.

18. The method of claim 17, comprising generating the mixture of the first data and the second data via providing a weighting of a relative value of the first data with respect to the second data in generating the mixture of the first data and the second data.

19. The method of claim 18, wherein receiving the first data comprises receiving field data measured during natural resource operations.

20. The method of claim 19, wherein receiving the second data comprises receiving lab data measured in conjunction with a controlled environment as a second portion of the first data.
